(19) United States
(12) Patent Application Publication
(10) Pub. No.: US 2002/0078023 A1
(43) Pub. Date: Jun. 20, 2002

(54) Method and system for combining user-supplied sort information with secondary sort information

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/973,678

(22) Filed: Oct. 5, 2001

Related U.S. Application Data
(60) Provisional application No. 60/238,791, filed on Oct. 6, 2000.
(60) Provisional application No. 60/238,577, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.
(60) Provisional application No. 60/237,249, filed on Oct. 2, 2000.
(60) Provisional application No. 60/337,252, filed on Dec. 3, 2001.

(51) Int. Cl. G06F 7/00

(52) U.S. Cl. 707/1

(57) ABSTRACT

A method and system whereby users can control the primary sort criteria while retaining the benefit of also sorting by non-redundant portions of default sort criteria and/or by additional criteria that is implied by the user's explicit choice; in either case reducing the time and effort spent finding and understanding information. A computer with appropriate software adapts the default and/or implied sort criteria to fit the user-supplied sort criteria.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to organizing information retrieved from data repositories, and more particularly to a method and system for combining user-supplied sort information with secondary sort information to give the user control over the primary sort order and the benefit of additional sorting that they did not have to specify.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving, organizing and understanding relevant information also increases. To locate relevant information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). These systems typically organize retrieved information by sorting based on the value of one or more fields. According to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, which generally support sorting by specific fields or columns, full-text collections which may or may not support sorting by fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled).

As is well known in the art, sorting data by the contents of a data element consists of ordering the data objects such that the contents of the corresponding data element in each successive data object are logically after (or, in the case of inverse order, logically before) the value or contents of the prior object, e.g. in alphabetical order for text, numerical order for numbers, or chronological order for dates. The phrase “sorting by a data element” and similar may be used herein as shorthand for the process that is more precisely described as “sorting by the contents of a data element.”

Methods for sorting data objects by one or more data elements are well known in the art, using algorithms such as the bubble sort, shell sort or quick sort. Sorting data by a plurality of data elements is known in the art as a “multi-level” sort, e.g. first sorting by data element “A” and then, for every identical value within “A,” sorting by data element “B.”

Typically, a user inputs or selects a plurality of data element identifiers, and may select an associated sort direction (e.g. ascending, descending or custom) for one or more of these data element identifiers. If the user does not specify a sort order, a system may supply a default sort order. However, in the prior art, if the user specified a sort order, it would supercede and replace the default sort order.

Users encounter an additional problem when specifying sort criteria: computers generally do what they are told to do even when that does not correspond to what the user intended. For example, if a user elects to sort by “City” in a search system for job openings, apartments for rent, or houses for sale, and the user's search criteria matches items in multiple states, the system's literal sort by city would mix together data from different states, e.g. “Boston, Mass.; Nashua, N.H.; Quincy, Mass.

In summary, the prior art does not provide a way for a user to take advantage of default multi-level sort criteria and still have control over the primary sort criteria, and does not take advantage of information which may be implied by a user's explicit choice.

### SUMMARY OF THE INVENTION

In the present invention, a computer with appropriate software merges a list of data element identifiers supplied by the user with data element identifiers representing default sort information and/or implied sort information.

The present invention overcomes the prior art limitations by giving a user control over the primary sort criteria while retaining the benefit of also sorting by compatible, non-redundant portions of default sort criteria. The present invention also overcomes the prior art limitations by giving a user control over the primary sort criteria while retaining the benefit of also sorting by criteria that is implied by the user's explicit choice.

It is an object of the invention to reduce the time and frustration associated with finding and understanding information, by enabling information systems to provide rich default and implied sort criteria that adapt to the user's preferred primary sort criteria. It is a further object of the invention to enable computers to automate the process of organizing information in a useful manner while remaining flexible enough to adapt to user input.

Other objects and advantages of the invention will, in part, be obvious, and, in part, be shown from the following description.

### BRIEF DESCRIPTION OF THE DRAWINGS

FIG. 1 is a schematic representation depicting one illustrative embodiment of the invention, wherein the invention is coupled to a sort engine;

FIGS. 2a, 2b and 2c depict illustrative input values and the corresponding output values;

FIG. 3 is a flow chart depicting the steps for one illustrative method of one illustrative embodiment of the invention;

FIG. 4 is a schematic representation depicting one illustrative embodiment of the invention, wherein the invention is coupled to a network;

FIG. 5 is a schematic representation depicting one illustrative embodiment of the invention, wherein the invention interacts with a single electronic device.

### LIST OF REFERENCE NUMERALS

10 System coupled to a sort engine

12 filter

14 instruction port

16 secondary port

18 output port

20 sort engine

22 data producer

24 data consumer

28 server computer

50 System with network

52A-52C IADs

54A-54C Web browsers

56 network

58 HTTP Web server

62 search engine

64 data repository

66 formatting engine

68 server computer

90 System with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

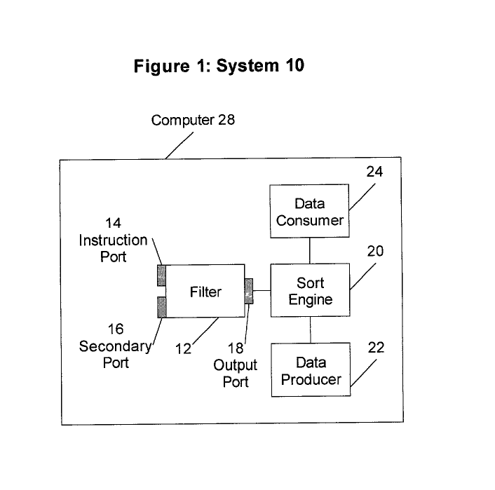

FIG. 1 depicts an illustrative embodiment of one system 10 according to the invention which combines user-supplied sort information with secondary sort information. The system comprises a filter 12 containing an instruction port 14, a secondary port 16, and an output port 18, which is coupled to a sort engine 20 which in turn gets input from a data producer 22 and sends output to a data consumer 24.

For this illustrative embodiment, the filter 12 with ports 14, 16 and 18, sort engine 20, data producer 22 and data consumer 24 reside on a single computer 28 which may be a Macintosh G3 running MacOS 8.5. For this illustrative embodiment, the filter 12 is coded in the UserTalk language embedded in UserLand Frontier, a commercial scripting and Web development system; sort engine 20 and data producer 22 are commercial database management software known as FileMaker Pro, and data consumer 24 may be any additional function, routine or procedure coded in the UserTalk language embedded in UserLand Frontier.

It will be readily apparent to those skilled in the art that the computer 28 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 28 could be divided among a plurality of computers from the same or different manufacturers, with each computer running the same or different operating systems.

It will be readily apparent to those skilled in the art that filter 12 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc.

It will be readily apparent to those skilled in the art that sort engine 20 and data producer 22 could be any suitable database management system such as Oracle, Informix, Sybase, SQL Server, Access, mySQL, PostgreSQL, etc. or full-text search and sort engine and associated collection or other index mechanism such as those provided by Verity, UltraSeek, Thunderstone, etc., and/or other software capable of storing and searching data. It will be further apparent that sort engine 20 and data producer 22 need not be implemented using the same software nor even reside on the same computer.

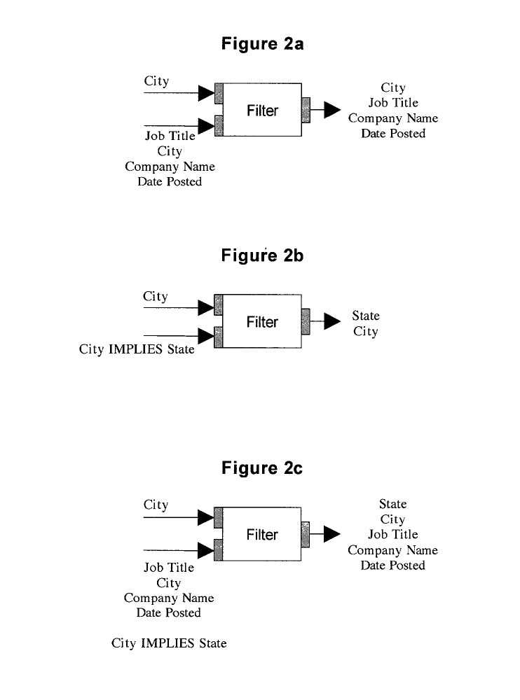

With this illustrative embodiment of the invention, users have control over the primary sort criteria without losing the benefit of secondary sort criteria. FIG. 2a illustrates one embodiment where the secondary sort criteria is a default multi-level sort. If a user is reviewing a list of job openings, she may elect to sort the openings by “City” in order to help her locate a nearby opening. To better organize the result, the job sorting system may provide a default multi-level sort consisting of “Job Title, City, Company Name, Date Posted.” The filter 12 will merge the two criteria, eliminating the second occurrence of “City,” thus yielding “City, Job Title, Company Name, Date Posted.”

FIG. 2b illustrates a further example, where the secondary sort criteria is an implied sort. Depending on the source of the list of job openings, the list may include openings from multiple states. To better organize the result, the job sorting system may specify that a request to sort by “City” implies a more general sort by geography, and hence a prior sort by “State” (or “Province” or the like). If the user elects to sort the openings by “City,” the filter 12 will merge the explicit and implied criteria, thus yielding “State, City.”

FIG. 2c illustrates a combination of the above two examples, where the secondary sort criteria includes both default multi-level sort and implied sort. If the user elects to sort job openings by “City,” the filter 12 will first insert the implied criteria and then merge with the default criteria, thus yielding “State, City, Job Title, Company Name, Date Posted.” In all of these examples, a system according to this invention reduces the time and effort spent finding information by organizing the data to multiple levels without requiring that the user explicitly list each and every level.

It will be readily apparent to those skilled in the art that the implied sort criteria could be used to insert additional criteria before the user's criteria (as shown above), or after the user's criteria (e.g. given “State,” add “City” after), or to replace the user's criteria (e.g. “City” with a compound “State-City”), or some combination thereof.

### Operation

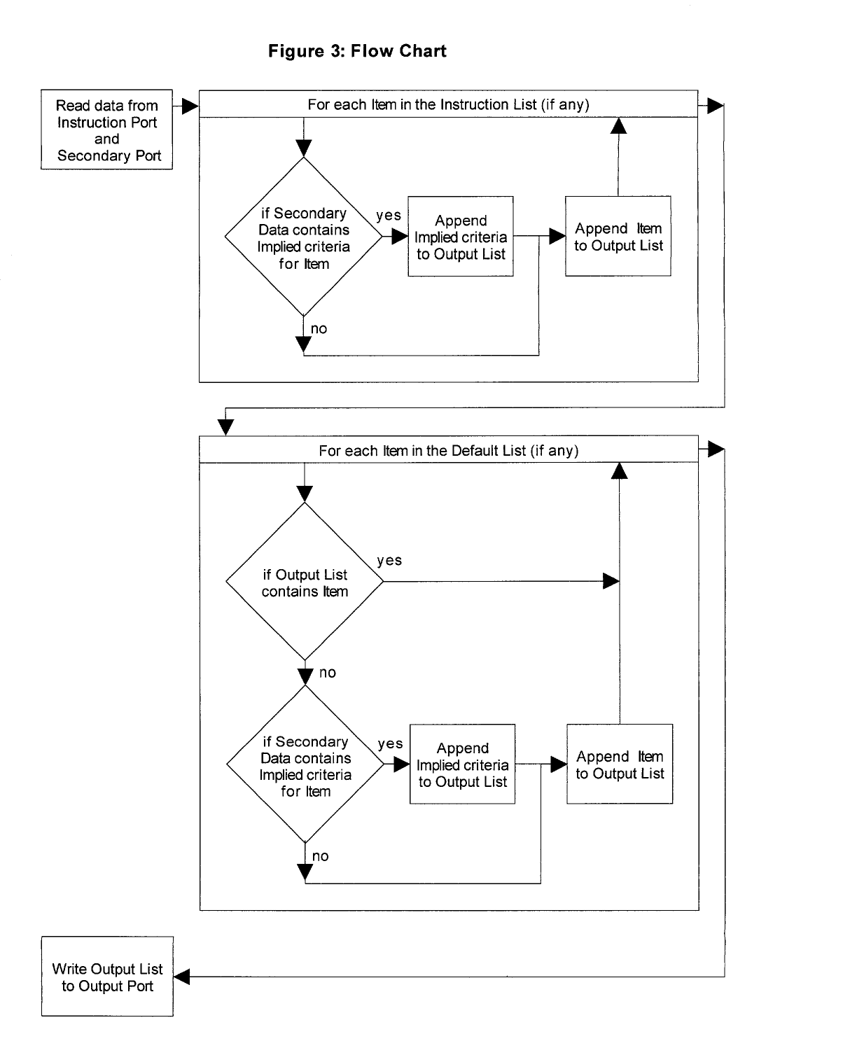

FIG. 3 is a flow chart that depicts the operation of this illustrative embodiment. Filter 12 receives data from instruction port 14 and secondary port 16, then iterates over each Item in the Instruction List, if any. If any implied criteria exists for any Instruction Item, that criteria is appended to an Output List; in either case, the Item is appended. Filter 12 then iterates over each Item in the Default list, if any. If the Output List already contains the Item, the Default Item is skipped; otherwise, if any implied criteria exists for the Default Item, that is appended to the Output List, the Default Item is then appended. Filter 12 then sends the Output List through the output port 18 for use by a sort engine, or otherwise.

It will be readily apparent to those skilled in the art that filter 12 could perform the same function using somewhat different steps or varying the order of certain steps, and could accept and process the Instruction List, Default List and Implied List in a variety of formats, each of which may differ from the other.

### Alternative Embodiments

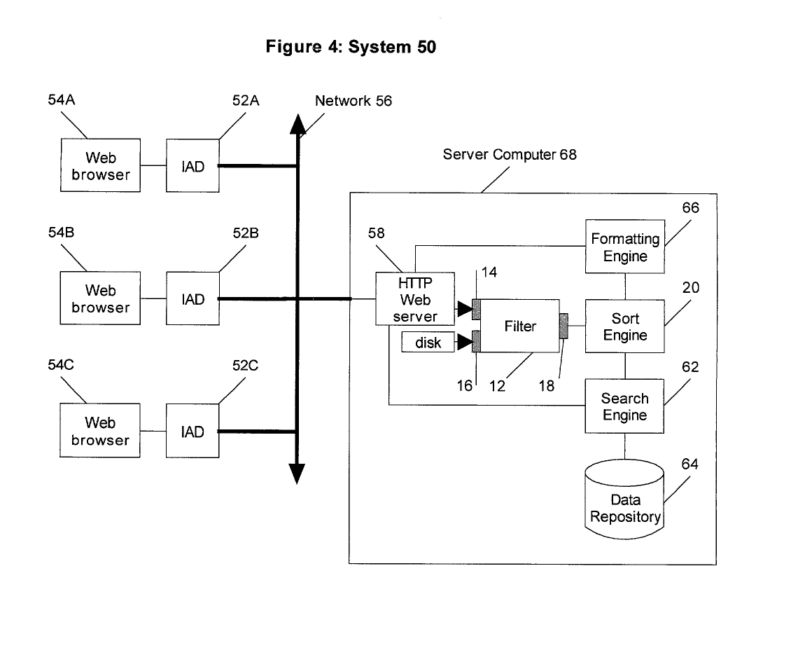

FIG. 4 depicts another illustrative embodiment of one system 50 according to the invention which combines sort information supplied by the user over a network with secondary sort information stored locally. The system comprises a plurality of IADs 52A-52C, each integrated with or coupled to a Web browser 54A-54C and coupled to a network 56, which is in turn coupled to an HTTP Web server 58, which is coupled to a filter 12 via instruction port 14 according to the current invention. Secondary port 16 is configured to read data from disk. HTTP Web server 58 is also coupled to a search engine 62. The filter 12 is coupled via output port 18 to a sort engine 20 which is coupled to search engine 62 which is coupled both to a data repository 64 (the pair acting as a data producer) and a formatting engine 66 (acting as a data consumer). The formatting engine 66 is coupled to the HTTP Web server 58 in order to return matching data to the IADs 52A-52C to display for the users on client processes such as Web browsers 54A-54C.

For this illustrative embodiment, the HTTP Web server 58, disk, filter 12 with ports 14, 16 and 18, sort engine 20, search engine 62, data repository 64 and formatting engine 66 reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that filter 12 and other components could be coded in any suitable scripting or programming language such as Perl, JavaScript, Java, VBScript, Visual BASIC, C++, etc. or any suitable content management system or application server such as Vignette StoryServer, Allaire ColdFusion, SilverStream, etc. and interact with HTTP Web server 58 via CGI, plug-in, servlets, Enterprise Java Beans, etc., and that the various components need not be coded in the same language or developed in the same content management system or application server.

Operation: The user controls one or more UDs to select sort criteria and search criteria via a Web browser 54 running on an IAD 52. The Web browser 54 sends the criteria over the network 56 via the HTTP protocol to the HTTP Web server 58 running on the server computer 68, which forwards the sort criteria to the filter 12 via instruction port 14, and the search criteria to search engine 62. Filter 12 adapts the sort criteria to secondary sort information received from secondary port 16, and sends the adapted sort criteria to sort engine 20, which receives data from search engine 62 and data repository 64, sorts the data according to the adapted sort criteria, and forwards the sorted data to the formatting engine 66. The formatting engine 66 formats the data as an HTML page and sends it to the HTTP Web server 58, which returns the HTML page over the network 56 via the HTTP protocol back to the user's Web browser 54 which displays it on the VDU of IAD 52.

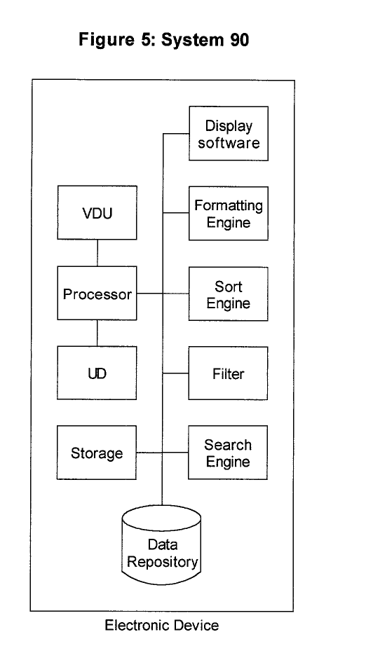

FIG. 5 depicts an illustrative embodiment of one system 90 which combines sort information supplied by the user with secondary sort information. The system comprises a single electronic device with at least one processor, at least one UD, at least one VDU and some form of storage, with the system 90 running software configured as one or more components to display sort options, accept user input, accept secondary input, filter the user input and secondary input to create a merged sort criteria, perform a search on a local or embedded data repository, sort the results according to the merged sort criteria, format the sorted result and present the sorted result to the user on the VDU.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by giving a user control over the primary sort criteria while retaining the benefit of also sorting by compatible, non-redundant portions of default sort criteria and/or by additional criteria that is implied by the user's explicit choice; in either case reducing the time and effort spent finding and understanding information. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. An Adaptive Criteria Filtering System (ACFS) that assembles sort criteria for an Information Sorting Mechanism (ISM), the ACFS comprising:
an instruction port configured to receive an instruction list containing zero or more data element identifiers;
a secondary port configured to receive secondary sort criteria;
an output port configured to send an adapted list of data element identifiers to the ISM and/or to the mechanism that invoked the ACFS; and
a filter configured to:
receive the instruction list from the instruction port,
receive the secondary sort criteria from the secondary port,
create the adapted list by merging the instruction list with relevant portions of the secondary sort criteria which may include the entire secondary sort criteria, and
send the adapted list to the output port;
whereby the ACFS adapts secondary sort criteria to user-specified sort criteria, giving the user control over the primary sort order while retaining the benefit of the secondary sort criteria.

2. The ACFS recited in claim 1 wherein:
the secondary sort criteria includes a default list having at least one data element identifier; and
the filter assembles the adapted list consisting of the contents of the instruction list followed by each of the identifiers from the default list that are not in the instruction list.

3. The ACFS recited in claim 1 wherein:
the secondary sort criteria includes a list having at least one primary data element identifier and an associated list of zero or more implied data element identifers for each primary data element identifier; and
the filter assembles the adapted list by starting with an empty adapted list, iterating through the instruction list, and, for each item in the instruction list adding, without regard to order, one or both of the item itself and the implied data element identifiers, if any, that is associated with the item.

4. The ACFS recited in claim 3 wherein the filter first adds the implied data element identifers and then adds the item.

5. The ACFS recited in claim 4 wherein the implied data includes at least one of the following:
City IMPLIES Area Code;
City IMPLIES State;
City IMPLIES Province;
City IMPLIES Country, State;
City IMPLIES Country, Province;
State IMPLIES Country;
Company Name IMPLIES IsRecruitingAgency; and/or
Job Title IMPLIES IsContractPosition.

6. The ACFS recited in claim 3 wherein the filter first adds the item and then adds the implied data element identifers.

7. The ACFS recited in claim 6 wherein the implied data includes at least one of the following:
Area Code IMPLIES City;
State IMPLIES City;
Province IMPLIES City;
Country IMPLIES State; and/or
Country IMPLIES State, City.

8. The ACFS recited in claim 3 wherein the filter adds the implied data element identifers and does not add the item.

9. The ACFS recited in claim 8 wherein the implied data includes at least one of the ark following:
City IMPLIES AreaCode-City;
City IMPLIES State-City;
City IMPLIES Province-City;
City IMPLIES Country-State-City; and/or
City IMPLIES Country-Province-City.

10. The ACFS recited in claim 3 wherein the filter does not add any specific data element identifier to the adapted list if the adapted list already contains the identifier.

11. The ACFS recited in claim 3 wherein the filter adds every implied data element identifer that is implied by any implied data element identifier.

12. The ACFS recited in claim 1 wherein:
the secondary sort criteria includes a list having at least one default data element identifier and a list having at least one primary data element identifier and an associated list of zero or more implied data element identifers for each primary data element identifier; and
the filter assembles the adapted list by starting with an empty adapted list and:
iterating through the instruction list, and, for each item in the instruction list adding to the adapted list, without regard to order, one or both of the item itself and the implied data element identifiers, if any, that is associated with the item; and
iterating through the default list, and, for each item not in the adapted list, adding to the adapted list, without regard to order, one or both of the item itself and the implied data element identifiers, if any, that is associated with the item.

13. The ACFS recited in claim 1, further comprising a control port configured to receive an optional command; and wherein the filter reads the command from the control port, and, if the command indicates that the secondary sort criteria should not be used, the filter creates an adapted list identical to the instruction list.

14. The ACFS recited in claim 1 wherein the ISM is comprised of a database, a database management system, a search engine supporting full-text search and sorting by data elements within the text, and/or a sorting library or code module.

15. The ACFS recited in claim 1 wherein each data element is comprised of a database field, tagged data including HTML, XML, or SGML, meta data, and/or a document.

16. The ACFS recited in claim 1 wherein the secondary port is comprised of static data stored in a storage means.

17. The ACFS recited in claim 1 wherein the secondary port is configured to interact with code; and wherein the filter is configured to invoke the code in a procedural, object-oriented and/or other programmatic fashion.

18. The ACFS recited in claim 1 wherein the instruction port is coupled to an HTTP Web server, or coupled to a computer-readable media, or configured to communicate via a standard electronic messaging protocol.

19. The ACFS recited in claim 1 wherein the output port is configured to interact with code; and wherein the filter is configured to invoke the ISM in a procedural, object-oriented and/or other programmatic fashion.

20. The ACFS recited in claim 1 wherein the ACFS is implemented as a script embedded in, and/or linked to, a document employing a markup language including HTML, XML or SGML.

21. The ACFS recited in claim 1 wherein the ACFS is implemented as a desktop, clientserver, and/or n-tier application.

22. The ACFS recited in claim 1 wherein the filter is further configured to translate the adaptive list to the syntax and/or the format of the target ISM.

23. The ACFS recited in claim 1 wherein each data element is part of a data object, the data object having at least one data unit of employment information.

24. A sort system comprising:
an ACFS as recited in claim 1; and
an ISM coupled to the ACFS, to a data producer, and to a data consumer, the ISM being configured to receive the sort criteria in a predetermined syntax, receive the data from the data producer, sort the data according to the sort criteria, and forward the sorted data to the data producer.

25. A search system comprising:
an ACFS as recited in claim 1;
a search port configured to receive search criteria;
an Information Location Mechanism (ILM) configured to locate zero or more data objects that match the received search criteria;
an Information Formatting Mechanism (IFM) configured to format data;
an ISM coupled to the ACFS, to the ILM, and to IFM, the ISM being configured to receive the sort criteria in a predetermined syntax, receive a plurality of data objects from the ILM, sort the data according to the sort criteria, and forward the sorted data objects to the IFM; and
a client process and VDU to display the formatted data objects.

26. The search system recited in claim 25 wherein the data formatting employs a markup language including HTML, XML or SGML.

27. The search system recited in claim 25 wherein the contents of at least one data element of at least one data object contains employment information.

28. An adaptive criteria filtering method for assembling sort criteria for an Information Sorting Mechanism (ISM), the method comprising:
receiving an instruction list having zero or more data element identifiers;
receiving secondary sort criteria;
creating an adapted list of data element identifiers by merging the instruction list with relevant portions of the secondary sort criteria which may include the entire secondary sort criteria; and
sending the adapted list to the ISM and/or to the mechanism that invoked the method;
whereby the method adapts secondary sort criteria to user-specified sort criteria, giving the user control over the primary sort order while retaining the benefit of the secondary sort criteria.
